(19) United States
(12) Patent Application Publication
(10) Pub. No.: US 2007/0001948 A1
(43) Pub. Date: Jan. 4, 2007

(54) Liquid crystal display

(75) Inventors: Chang-Hun Lee, Yongin-si (KR); Hee-Seop Kim, Hwasung-si (KR); Jun-Woo Lee, Anyang-si (KR); Lujian Gang, Yongin-si (KR); Eun-Hee Han, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/480,653

(22) Filed: Jul. 3, 2006

(30) Foreign Application Priority Data
Jul. 4, 2005 (KR) 10-2005-0059676

(51) Int. Cl. G09G 3/36

(52) U.S. Cl. 345/87

(57) ABSTRACT

A liquid crystal display according to an embodiment of the present invention provides a OCB liquid crystal display that can stably operate without breaking the bending alignment regardless of applied voltage. The display includes first and second alignment layers that are formed on the first and second substrates, respectively, and that horizontally align the liquid crystal layer. A normal data voltage is determined based on a first gamma curve representing luminance corresponding to external image information and impulsive data voltages are determined based on a second gamma curve representing a luminance that is lower than that of the first gamma curve. The normal data voltage and the impulsive data voltage are applied periodically and alternately. A bending alignment is obtained without experiencing asymmetric splay alignment by creating an energy difference between the energy needed for the alignment to transition to the twist alignment adjacent to the upper alignment layer and the energy needed for the alignment to transition to the twist alignment adjacent to the lower alignment layer.

### CROSS-REFERENCE TO RELATED APPLICATION

This application claims priority to and the benefit of Korean Patent Application No. 10-2005-0059676 filed in the Korean Intellectual Property Office on Jul. 4, 2005, the entire contents of which are incorporated herein by reference.

### FIELD OF THE INVENTION

The present invention relates to a liquid crystal display.

### DESCRIPTION OF THE RELATED ART

A liquid crystal display is one type of flat panel display that is now widely used. The liquid crystal display includes two display panel sheets in which pixel electrodes and common electrodes are formed. A voltage applied to the electrodes generates an electric field in the liquid crystal layer which determines the orientation direction of the liquid crystal molecules and controls the polarization of incident light to display an image. Of the liquid crystal displays, the optically compensated bend (OCB) method offers a wide reference viewing angle because the liquid crystal molecules are changed from a horizontal arrangement to a vertical arrangement until they reach from the substrate surface to the central surface while being symmetrical to the central surface between two substrates. To obtain the alignment of the liquid crystal molecules, the alignment layer of the two substrates undergoes an alignment process such as rubbing in one direction and then a high voltage is applied to produce the bending alignment. However, if the voltage drops below a certain value, the bending alignment of the liquid crystal layer may be broken but it is difficult to know when that value occurs.

### SUMMARY OF THE INVENTION

A liquid crystal display according to an embodiment of the present invention includes a first substrate, a first electrode formed on the first substrate, a second substrate opposite to the first substrate, a second electrode formed on the second substrate, a liquid crystal layer interposed between the first substrate and the second substrate and aligned in an OCB method, and first and second alignment layers that are formed on the first and second substrates, respectively, and that horizontally align the liquid crystal layer. A state of the first alignment layer and a state of the second alignment layer are different from each other. A normal data voltage, which is determined based on a first gamma curve representing luminance corresponding to external image information, and an impulsive data voltage, which is determined based on a second gamma curve representing a luminance that is lower than that of the first gamma curve, are periodically and alternately applied to the first electrode.

A linear tilt angle of liquid crystal molecules by the first alignment layer and a linear tilt angle of the liquid crystal molecules by the second alignment layer may be different from each other.

The first alignment layer and the second alignment layer may include different materials.

A thickness of the first alignment layer may be different from that of the second alignment layer.

The first alignment layer and the second alignment layer may be formed using different baking temperatures and times.

The first and second alignment layers may be rubbed, and an angle formed by a rubbing direction of the first alignment layer and by a rubbing direction of the second alignment layer may be 2° to 4°.

If the first alignment layer and the second alignment layer are rubbed, any of a texture of a rubbing material, a rubbing strength, and a number of rubs may be different for each.

The second gamma curve may represent black with respect to a gray that is lower than a predetermined value.

The second gamma curve may represent a luminance that monotonically increases with respect to a gray that is higher than the predetermined value.

The second gamma curve may represent black with respect to all grays.

The liquid crystal display may be of a normally white mode.

The impulsive data voltage may be higher than a voltage at which a bending alignment of the liquid crystal layer is broken.

A liquid crystal display according to an embodiment of the present invention includes first and second electrodes disposed opposite to each other, and a liquid crystal layer that is interposed between the first electrode and the second electrode and forms a bending alignment. A normal data voltage representing luminance corresponding to external image information and an impulsive data voltage that is higher than the lowest voltage that can sustain the bending alignment are periodically and alternately applied to the first electrode.

The impulsive data voltage may represent black.

The impulsive data voltage may be varied depending on input image information.

The impulsive data voltage corresponding to a predetermined gray or less may represent black.

The liquid crystal display may be of a normally white mode.

The ratio of pixels to which the normal data voltage and the impulsive data voltage are applied may be 1:1.

### BRIEF DESCRIPTION OF THE DRAWINGS

FIG. 1 is a block diagram of a liquid crystal display according to an exemplary embodiment of the present invention.

FIG. 2 is an equivalent circuit diagram of one pixel of the liquid crystal display according to an exemplary embodiment of the present invention.

FIG. 3 is a layout view of a liquid crystal panel assembly according to an exemplary embodiment of the present invention.

FIG. 4 is a cross-sectional view of the liquid crystal panel assembly taken along the line IV-IV in FIG. 3.

FIG. 5 illustrates an alignment state of liquid crystal molecules before a voltage is applied to pixel electrodes and common electrodes.

FIGS. 6 and 7 illustrate an alignment state of the liquid crystal molecules after a voltage is applied to the electrodes.

FIG. 8 illustrates an alignment state of the liquid crystal molecules, which may occur between the states of FIGS. 6 and 7.

FIG. 9 is a graph showing a gamma curve of the liquid crystal display according to an exemplary embodiment of the present invention.

FIG. 10 shows a waveform of a data signal in the liquid crystal display according to an exemplary embodiment of the present invention.

FIG. 11 is a graph in which the luminance of the liquid crystal display according to an exemplary embodiment of the present invention is represented as a function of a normal data voltage in the case where only the normal data voltage is applied.

FIG. 12 is a graph in which the luminance of the liquid crystal display according to an exemplary embodiment of the present invention is represented as a function of a normal data voltage in the case where impulsive data voltages are applied between times when normal data voltages are applied.

### DETAILED DESCRIPTION

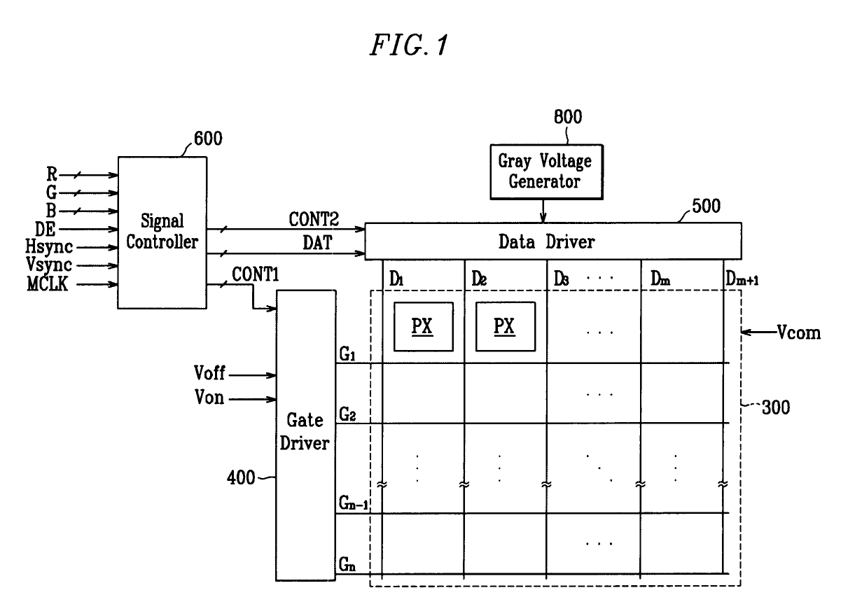

To clarify the depiction of multiple layers and regions, the thicknesses of the layers are enlarged in the drawings. Like reference numerals designate like elements throughout the specification. As shown in FIG. 1, the liquid crystal display according to an exemplary embodiment of the present invention includes a liquid crystal panel assembly 300, a gate driver 400 and a data driver 500 connected to the liquid crystal panel assembly 300, a gray voltage generator 800 connected to the data driver 500, and a signal controller 600 that controls the above-mentioned elements.

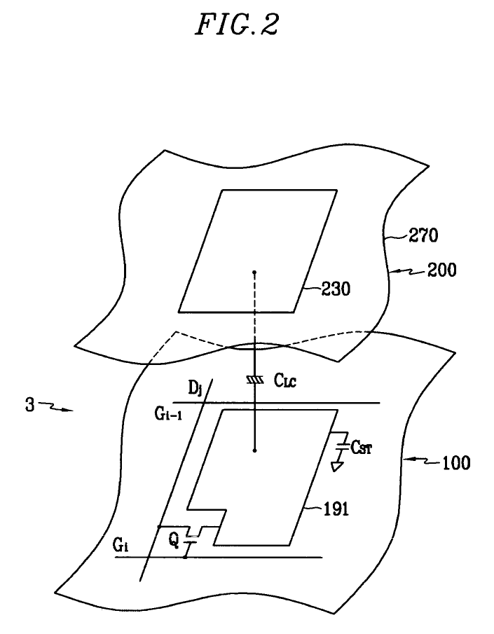

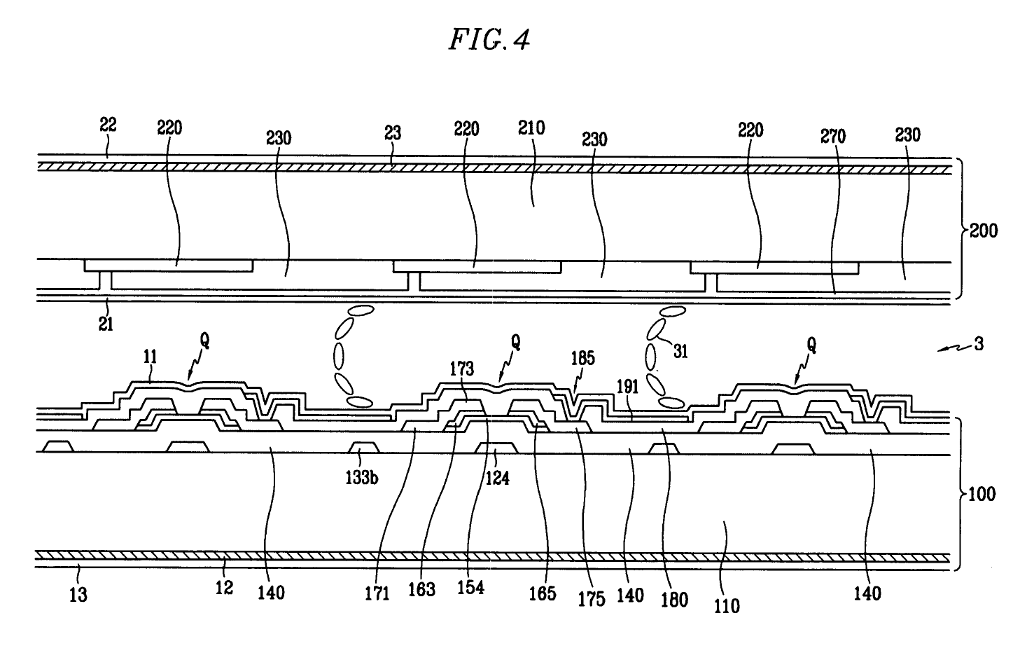

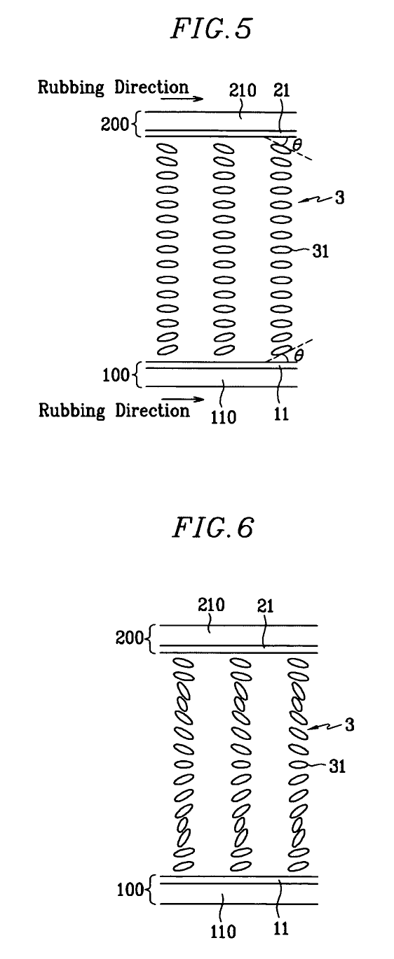

The liquid crystal panel assembly 300 includes a plurality of display signal lines (G₁-Gₙ, D₁-Dₘ), and a plurality of pixels (PX) that are connected to the signal lines and are approximately arranged in a matrix form, when viewed in an equivalent circuit diagram. As shown in FIG. 2, the liquid crystal panel assembly 300 includes lower and upper panels 100 and 200 that are opposite to each other, and a liquid crystal layer 3 interposed between the lower and upper panels 100 and 200. The liquid crystal layer 3 includes OCB liquid crystals having a bending alignment, which are symmetrical to each other on the basis of the central surface of the lower and upper panels 100 and 200, as shown in FIG. 4. A method of forming the bending alignment will be described later with reference to FIGS. 5 to 8.

The signal lines (G₁-Gₙ, D₁-Dₘ) include a plurality of gate lines (G₁-Gₙ) that transfer a gate signal (also referred to as a “scanning signal”), and a plurality of data lines (D₁-Dₘ) that transfer a data signal. The gate lines (G₁-Gₙ) extend approximately in a row direction and are almost parallel to each other. The data lines (D₁-Dₘ) extend approximately in a column direction and are almost parallel to each other. Each pixel (PX), e.g., a pixel (PX) connected to an i-th (i=1, 2, . . . , n) gate line (Gi) and a j-th (j=1, 2, . . . , m) data line (Dj), includes a switching element Q connected to the signal lines (Gi, Dj), and a liquid crystal capacitor (C_{LC}) and a storage capacitor (C_{ST}) connected to the switching element Q. The storage capacitor (C_{ST}) may be omitted, if appropriate.

The switching element Q is a three-terminal element of a thin film transistor, etc., which is included in the lower panel 100. The switching element Q has a control terminal connected to the gate lines (G₁-Gₙ), an input terminal connected to the data lines (D₁-Dₘ), and an output terminal connected to the liquid crystal capacitor (C_{LC}) and the storage capacitor (C_{ST}). The liquid crystal capacitor (C_{LC}) uses a pixel electrode 191 of the lower panel 100 and a common electrode 270 of the upper panel 200 as two terminals. The liquid crystal layer 3 between the two electrodes 191 and 270 functions as a dielectric material. The pixel electrode 191 is connected to the switching element Q, and the common electrode 270 is formed on the entire surfaces of the upper panel 200 and is applied with a common voltage Vcom. Unlike as shown in FIG. 2, the common electrode 270 may be disposed in the lower panel 100. At least one of the two electrodes 191 and 270 may have a linear or bar shape. In the storage capacitor (C_{ST}) serving to assist the liquid crystal capacitor (C_{LC}), a separate signal line (not shown) provided in the lower panel 100 and the pixel electrode 191 are overlapped with an insulator therebetween. The separate signal line is applied with a predetermined voltage such as the common voltage Vcom. In the storage capacitor (C_{ST}), however, the pixel electrode 191 may be overlapped with an immediately upper front gate line through the medium of the insulator.

To implement color display, each pixel (PX) may uniquely display one of the primary colors (spatial division) or each pixel (PX) may display the primary colors alternately depending on time (temporal division), so that a desired color is recognized through a spatial and temporal sum of these primary colors. An example of the primary colors may include three primary colors such as red, green, blue, and the like. FIG. 2 shows an example of spatial division, wherein each pixel (PX) includes a color filter 230 that represents one of the primary colors on the region of the upper panel 200 corresponding to the pixel electrode 191. Unlike as shown in FIG. 2, the color filter 230 may be formed on or below the pixel electrode 191 of the lower panel 100. The liquid crystal display may also include a backlight unit (not shown) that supplies light to the panels 100 and 200 and the liquid crystal layer 3.

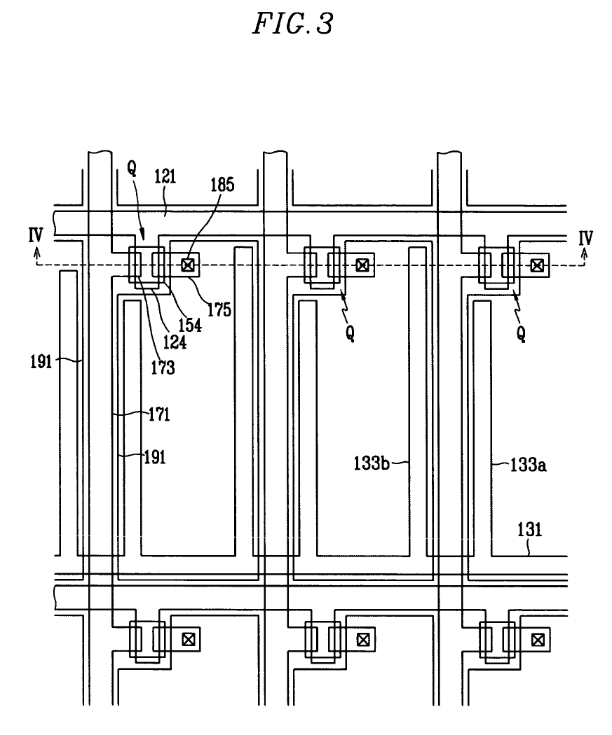

The structure of the liquid crystal panel assembly will be described below in detail with reference to FIGS. 3 and 4. FIG. 3 is a layout view of a liquid crystal panel assembly according to an exemplary embodiment of the present invention, and FIG. 4 is a cross-sectional view of the liquid crystal panel assembly taken along the line IV-IV in FIG. 3. As shown in FIG. 4, the liquid crystal panel assembly according to an exemplary embodiment of the present invention includes a lower panel 100 and an upper panel 200, and a liquid crystal layer 3 interposed between the lower panel 100 and the upper panel 200. The lower panel 100 will be described first.

A plurality of gate lines 121 and a plurality of storage electrode lines 131 are formed on an insulation substrate 110 made of transparent glass or plastic. The gate lines 121 function to transfer a gate signal, and they generally extend in a horizontal direction. Each of the gate lines 121 includes a plurality of gate electrodes 124 extending downwardly, and an end portion (not shown) having a wide area for connection to other layers or an external driving circuit. A gate driving circuit (not shown) that generates the gate signal may be mounted on a flexible printed circuit film (not shown) attached on the substrate 110, directly mounted on the substrate 110, or integrated with the substrate 110. In the case where the gate driving circuit is integrated with the substrate 110, the gate lines 121 may extend and then be directly connected to the gate driving circuit.

The storage electrode lines 131 are applied with a predetermined voltage, and they include a stem line extending almost in parallel to the gate lines 121 and plural pairs of storage electrodes 133a and 133b that are branched off from the stem line. Each of the storage electrode lines 131 is located between two adjacent gate lines 121. The stem line is located close to a lower side of the two gate lines 121. Each of the storage electrodes 133a and 133b includes a fixed terminal connected to the stem line and a free terminal opposite to the fixed terminal. However, the shape and disposition of the storage electrode lines 131 may be modified in various manners.

The gate lines 121 and the storage electrode lines 131 may be formed using an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti), or the like. However, they may have a multi-film structure including two conductive layers (not shown) having different physical properties. One of the conductive layers may be formed using a metal having low resistivity, such as an aluminum-based metal or a copper-based metal, in order to reduce signal delay or voltage drop.

Unlike the above, other conductive layers may be formed using materials having good physical, chemical, and electrical contact characteristics with, particularly, ITO (indium tin oxide) and IZO (indium zinc oxide), such as a molybdenum-based metal, chromium, tantalum, titanium, or the like. Preferred examples of the combination may include a lower chromium film and an upper aluminum (alloy) film, and a lower aluminum (alloy) film and an upper molybdenum (alloy) film. It is, however, to be understood that the gate lines 121 and the storage electrode lines 131 may be formed using several metals or conductors other than the above-mentioned metals.

The lateral surfaces of the gate lines 121 and the storage electrode lines 131 are tilted from the surface of the substrate 110. The tilt angle may be in the range of about 30° to about 80°. A gate insulating layer 140 made of silicon nitride (SiNx) or silicon oxide (SiOx) is formed on the gate lines 121 and the storage electrode lines 131. A plurality of island-type semiconductors 154 made of hydrogenated amorphous silicon (commonly abbreviated to “a-Si”), polysilicon, or the like are formed on the gate insulating layer 140. The island-type semiconductors 154 are located on the gate electrodes 124. A plurality of island ohmic contacts 163 and 165 are formed on the island-type semiconductors 154. The ohmic contacts 163 and 165 may be formed using a material such as n+ hydrogenated amorphous silicon into which an n-type impurity is doped at a high concentration, or silicide. The ohmic contacts 163 and 165 form a pair and are disposed on the island-type semiconductors 154. The lateral surfaces of the island-type semiconductors 154 and the ohmic contacts 163 and 165 are also tilted from the surface of the substrate 110. The tilt angle may be within a range of about 30° to 80°.

A plurality of data lines 171 and a plurality of drain electrodes 175 are formed on the ohmic contacts 163 and 165 and the gate insulating layer 140. The data lines 171 function to transfer the data signals, and they generally extend in a vertical direction and cross the gate lines 121. Each of the data lines 171 also crosses each of the storage electrode lines 131, and runs between adjacent storage electrodes 133a and 133b. Each data line 171 also crosses the stem line of the storage electrode lines 131. Each data line 171 includes a plurality of source electrodes 173 extending toward the gate electrode 124, and an end portion (not shown) having a wide area for connection to other layers or an external driving circuit. A data driving circuit (not shown) that generates the data signals may be mounted on a flexible printed circuit film (not shown) attached on the substrate 110, directly mounted on the substrate 110, or integrated with the substrate 110. In the case where the data driving circuit is integrated with the substrate 110, the data lines 171 may extend and may then be directly connected to the data driving circuit.

The drain electrodes 175 are separated from the data lines 171 and are opposite to the source electrodes 173 with respect to the gate electrodes 124. One gate electrode 124, one source electrode 173, and one drain electrode 175 constitute one thin film transistor (TFT) Q along with an island-type semiconductor 154. The channel of the thin film transistor Q is formed in the island-type semiconductor 154 between the source electrode 173 and the drain electrode 175. The data lines 171 and the drain electrodes 175 may be formed using a refractory metal such as molybdenum, chromium, tantalum, or titanium, or an alloy thereof, and may have a multi-film structure including a refractory metal film (not shown) and a low resistance conductive layer (not shown). Examples of the multi-film structure may include a dual film of a lower chromium or molybdenum film and an upper aluminum (alloy) film, and a triple film of a lower molybdenum (alloy) film, an intermediate aluminum (alloy) film, and an upper molybdenum (alloy) film. It is, however, to be noted that the data lines 171 and the drain electrodes 175 may be formed using various metals or conductors other than the above-mentioned materials.

The lateral surfaces of the data lines 171 and the drain electrodes 175 may be tilted about 30° to 80° from the surface of the substrate 110. The ohmic contacts 163 and 165 exist only between the island-type semiconductors 154 below the ohmic contacts 163 and 165, and the data lines 171 and the drain electrodes 175 on the ohmic contacts 163 and 165, and they function to reduce contact resistance therebetween. A passivation layer 180 is formed on the data lines 171, the drain electrode 175, and the exposed island-type semiconductor 154 portions. The passivation layer 180 may be formed using an inorganic insulator, an organic insulator, or the like, and may have a flat surface. Examples of the inorganic insulator may include silicon nitride and silicon oxide. The organic insulator may have photosensitivity and may have a dielectric constant of about 4.0 or less. However, the passivation layer 180 may have a dual film structure of a lower inorganic film and an upper organic film so that it protects the exposed island-type semiconductors 154 while keeping maintaining the superior insulating characteristic of the organic film.

A plurality of contact holes (not shown) are formed in the passivation layer 180, through which the end portions (not shown) of the data lines 171 are exposed. A plurality of contact holes (not shown) are formed in the passivation layer 180 and the gate insulating layer 140, through which the end portions (not shown) of the gate lines 121 are exposed. A plurality of pixel electrodes 191 and a plurality of contact assistant members (not shown) are formed on the passivation layer 180. They may be formed of a transparent conductive material such as ITO or IZO, or a reflective metal such as aluminum, silver, chromium, or an alloy thereof.

The pixel electrodes 191 are physically and electrically connected to the drain electrodes 175 through contact holes 185, and are supplied with the data signals from the drain electrodes 175. The pixel electrodes 191 to which the data signals are applied generate an electric field along with the common electrode 270 of the display panel 200 to which the common voltage is applied, thereby determining the orientation of liquid crystal molecules 31 of the liquid crystal layer 3 between the two electrodes 191 and 270. The polarization of light that passes through the liquid crystal layer 3 is varied depending on the direction of the liquid crystal molecule 31, which is determined as described above. The pixel electrode 191 and the common electrode 270 constitute the liquid crystal capacitor that maintains a voltage that has been applied thereto even after the thin film transistor is turned off.

The pixel electrodes 191 are overlapped with the storage electrode lines 131 as well as the storage electrodes 133a and 133b. The left and right sides of each of pixel electrode 191 are adjacent to the data lines 171 rather than to the storage electrodes 133a and 133b. The pixel electrodes 191 and the drain electrodes 175 that are electrically connected to the pixel electrodes 191 are overlapped with the storage electrode lines 131, thus forming the storage capacitor that enhances the voltage storage capability of the liquid crystal capacitor.

The contact assistant members (not shown) are connected to the end portions (not shown) of the gate lines 121 and the end portions (not shown) of the data lines 171 through respective contact holes (not shown). The contact assistant members (not shown) enhance the adhesive property between the end portions (not shown) of the gate lines 121, the end portions (not shown) of the data lines 171, and an external apparatuses, and protect them.

The upper panel 200 will be described below.

Black matrices 220 are formed on an insulation substrate 210 that is made of transparent glass, plastic, or the like. Each black matrix 220 includes a linear portion (not shown) corresponding to the data line 171 and a planar portion (not shown) corresponding to the thin film transistor. The black matrix 220 blocks light leakage between the pixel electrodes 191.

A plurality of color filters 230 are also formed on the substrate 210. The color filters 230 mostly exist within regions surrounded by the black matrices 220, and may extend in a vertical direction along the column of the pixel electrodes 191. Each of the color filters 230 may display one of the primary colors such as three primary colors of the red, green, and blue. An overcoat may be formed on the color filters 230 and the black matrices 220. The overcoat may be formed using an organic insulator. The overcoat functions to prevent the color filter 230 from being exposed and provides a flat surface. A common electrode 270 is formed on the color filters 230 and the black matrices 220. The common electrode 270 may be formed using a transparent conductor such as ITO or IZO.

Horizontal alignment layers 11 and 21, which are rubbed in the same direction, are coated on the inner surfaces of the display panels 100 and 200. Polarizers 12 and 22 are provided on the outer surfaces of the display panels 100 and 200. Transmissive axes of the two polarizers 12 and 22 are orthogonal to each other. One of the transmissive axes may be parallel to the gate lines 121. In the case of a reflective liquid crystal display, one of the two polarizers 12 and 22 may be omitted. Reference numerals 13 and 23 respectively indicate compensation films. A compensation film may be attached between the polarizers 12 and 22 and the display panels 100 and 200. A C plate compensation film, a biaxial compensation film, or the like may be used as the compensation film. The liquid crystal layer 3 includes a nematic liquid crystal with positive dielectric anisotropy and that is aligned by an optically compensated bend (OCB) method. This will be described in detail with reference to FIGS. 5 to 8.

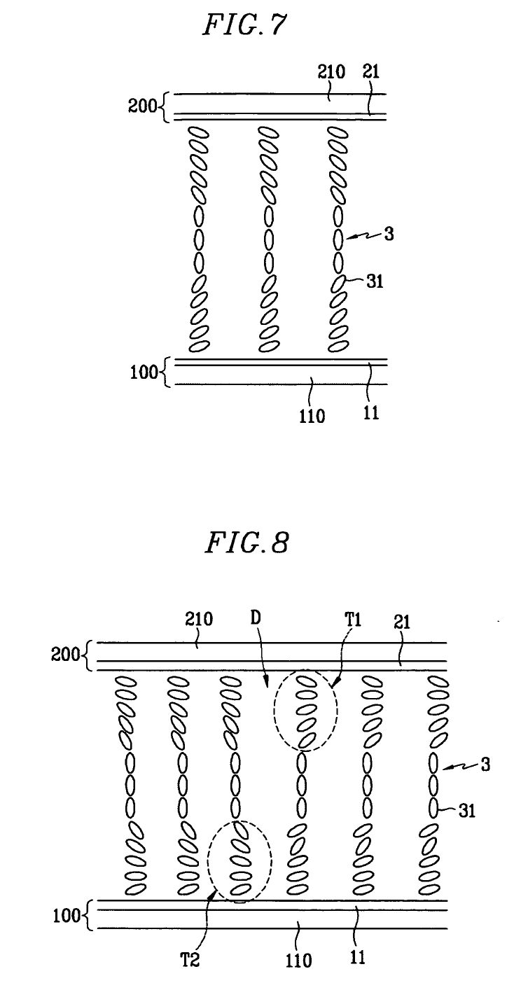

FIGS. 5 to 8 are schematic cross-sectional views illustrating the alignment of the liquid crystal molecules in the liquid crystal display shown in FIGS. 3 and 4. For better comprehension and ease of description, only the liquid crystal layer 3, the lower and upper substrates 110 and 210, the lower and upper alignment layers 11 and 21, and the liquid crystal molecules 31 are shown. The two alignment layers 11 and 21 are rubbed in the same direction. FIG. 5 illustrates an alignment state of the liquid crystal molecules 31 before a voltage is applied to the pixel electrodes 191 and the common electrode 270, and FIGS. 6 and 7 illustrate an alignment state of the liquid crystal molecules 31 after a voltage is applied to the electrodes 191 and 270. FIG. 8 illustrates an alignment state of the liquid crystal molecules 31, which may occur between the states of FIGS. 6 and 7.

Referring to FIG. 5, in a state where a voltage is not applied, the liquid crystal molecules 31 near the two alignment layers 11 and 21 are horizontally aligned at a linear tilt angle (θ) in which one end is raised toward the rubbing direction. Therefore, the alignments of the liquid crystal molecules 31 are close to parallel to the surfaces of the substrates 110 and 210 and are approximately symmetrical on the basis of the center of a surface (hereinafter, referred to as a “central surface”) which is located at approximately the same distance from the surfaces of the two alignment layers 11 and 21. Such an alignment is called a “splay alignment”.

In this state, if an electric field is applied to the liquid crystal layer 3, the alignment of the liquid crystal molecules 31 is changed from the splay alignment to other alignments. This will be described below with reference to FIGS. 6 to 8. If a voltage begins to be applied to the electrodes (not shown) of the two display panels 100 and 200, and an electric field that is vertical to the surfaces of the two display panels 100 and 200 is generated in the liquid crystal layer 3, the liquid crystal molecules 31 near the alignment layers 11 and 21 stand up in response to the electric field, as shown in FIG. 6. However, since the direction in which the liquid crystal molecules 31 stand up at the surfaces of the two alignment layers 11 and 21 is the same, the liquid crystal molecules 31 collide with each other in the central portion of the liquid crystal layer 3. Accordingly, high stress is generated which is transferred to a stable twist alignment in terms of energy. This is called a “transient splay alignment”. Such twist is not uniformly generated. For example, as shown in FIG. 8, twist may occur in a portion (T1) adjacent to the upper alignment layer 21 in any domain and twist may occur in a portion (T2) adjacent to the lower alignment layer 11 in any domain. At this time, the twist directions of the liquid crystal molecules 31 in the two domains (T1, T2) are opposite and energy states of the two domains (T1, T2) are the same. Accordingly, disclination (D) occurs at a location where asymmetric splay alignment is generated randomly and the two domains (T1, T2) meet.

In this state, if an electric field becomes strong, the liquid crystals result in a bending alignment as shown in FIG. 7. This will be described below in detail. A case where a voltage is raised at high speed and a case where a voltage is raised at low speed, when the voltage is applied to the electrodes of the lower panel 100 and the upper panel 200, will be described first. If the voltage is raised at high speed, the liquid crystals shift from the transient splay alignment step to the asymmetric splay alignment step. The two domains (T1, T2) whose twist directions are opposite to each other randomly occur. As described above, the two domains (T1, T2) have almost the same energy. Therefore, when a high voltage is applied, a stronger twist alignment occurs in order for the liquid crystals to transfer to the bending alignment regardless of the domains (T1, T2). Accordingly, there is no difference in luminance between the domains (T1, T2), but only the disclination (D) between the two domains becomes brighter and shaper. If a higher voltage is applied in this state, a slight energy difference occurs between the domain (T1) where the twist alignment is generated beginning from the upper alignment layer 21 and the domain (T2) where the twist alignment is generated beginning from the lower alignment layer 11. Furthermore, the twist alignments of the two domains (T1, T2) are integrated into a safer one of the two twist alignments and then transit to the bending alignment.

If the voltage is raised at a very slow speed, a symmetric splay state occurs in the same manner as when the voltage is raised at a high speed, but the boundary between the two domains is not clear and one of the two domains (T1, T2) is superior to the other of the two domains (T1, T2). Therefore, the two domains (T1, T2) are integrated into one, so that uniform alignment can be accomplished. If the voltage begins to be applied again, the alignment is easily changed to the bending alignment without generating the disclination. A case where a voltage applied to the electrodes of the lower panel 100 and the upper panel 200 is lowered at high speed and a case where a voltage applied to the electrodes of the lower panel 100 and the upper panel 200 is lowered at low speed, in the bending alignment state, will be described below.

If the voltage is lowered at high speed, the bending alignment is broken, and at the same time it transiions to a stable twist alignment in terms of energy. Even in this case, the two domains (T1, T2) having opposite twist directions appear as shown in FIG. 8. The two domains (T1, T2) include the domain (T1) where the twist alignment is generated beginning from the upper alignment layer 21 and the domain (T2) where the twist alignment is generated beginning from the lower alignment layer 11. Disclination clearly appears between the two domains (T1, T2). If the voltage is further lowered, one of the two domains (T1, T2) that has a lower energy than the other by even a marginal amount is superior to the other, and thus pushes the other, thereby forming one domain. Accordingly, the splay alignment is generated.

If the voltage is lowered at low speed, the alignment transitions to the twist alignment while the bending alignment is broken, but only some (upper or lower) part of the liquid crystal layer 3 experiences the twist alignment and the remaining amount experiences the bending alignment. If the voltage continues to gradually lower, one of the two domains that has a lower energy than that of the other becomes dominant and pushes the other. Accordingly, one domain is formed resulting in the splay alignment.

From the above fact, when an alignment transitions from an initial splay alignment to the bending alignment, it necessarily undergoes the twist alignment step. In the asymmetric splay alignment step, however, the two domains (T1, T2) having opposite twist directions exist. There is no inherent difference in energy between the two domains (T1, T2). Accordingly, a higher voltage is applied in order to break the equilibrium of the two domains and disclination continues so that the alignment transiions to the bending alignment.

Therefore, an exemplary embodiment of the present invention proposes a method of obtaining the bending alignment without experiencing asymmetric splay alignment. A method of removing the asymmetric splay alignment step includes causing an energy difference between the energy needed for the alignment to transition to the twist alignment adjacent to the upper alignment layer 21 and the energy needed for the alignment to transition to the twist alignment adjacent to the lower alignment layer 11.

To cause a difference in the energy as described above, the states of the alignment layers 11 and 21 are caused to be different from each other by differentiating conditions when the alignment layers 11 and 21 are formed or rubbed. This will be described after the process of forming the alignment layers 11 and 21 is briefly described. In general, the alignment layers 11 and 21 are formed by coating organic matter having a main chain and side chains along with a solvent, evaporating the solvent through primary baking, performing secondary baking, and then performing rubbing. The primary baking is performed in order to enhance the adhesive property between the alignment layers 11 and 21 and the substrates 110 and 210 or the thin film thereon, respectively. The secondary baking is carried out in order to improve the alignment property and strength of the alignment layers 11 and 21.

The other method of causing a difference in the energy includes differentiating a linear tilt angle of the upper alignment layer 21 and a linear tilt angle of the lower alignment layer 11. This is made possible by differentiating the length, density, etc. of each chain in the organic material (i.e., the material of the alignment layers 11 and 21). When the alignment layers 11 and 21 are formed using the same material, a difference in energy is made possible by differentiating the process conditions of the upper alignment layer 21 and the lower alignment layer 11. For example, a temperature and time of the primary baking process may be set to be different from those of the secondary baking processes, or a thickness of the lower alignment layer 11 may set to be different from that of the upper alignment layer 21. Furthermore, the rubbing conditions of the upper alignment layer 21 and the lower alignment layer 11 may be different from each other. For example, a texture of a rubbing material, a rubbing strength, a number of rubs, a rubbing table speed, a number of rotations of a rubbing roll, and so on, may be set to be different.

In addition, as an alternative method, the rubbing directions of the upper alignment layer 11 and the lower alignment layer 21 may be different from each other. If an angle of the rubbing direction of each of the two alignment layers 11 and 21 is too great, the compensation effect by the compensation film is low and a complete black state is difficult to obtain. It is therefore preferred that the angle is small if at all possible, e.g., about 2° to 4°. Such an alignment is called a “partially twisted bend (PTB) structure”. By doing so, although the transition to the twist alignment begins in the upper alignment layer 21 or the lower alignment layer 11, domain division does not occur since the twist directions are the same.

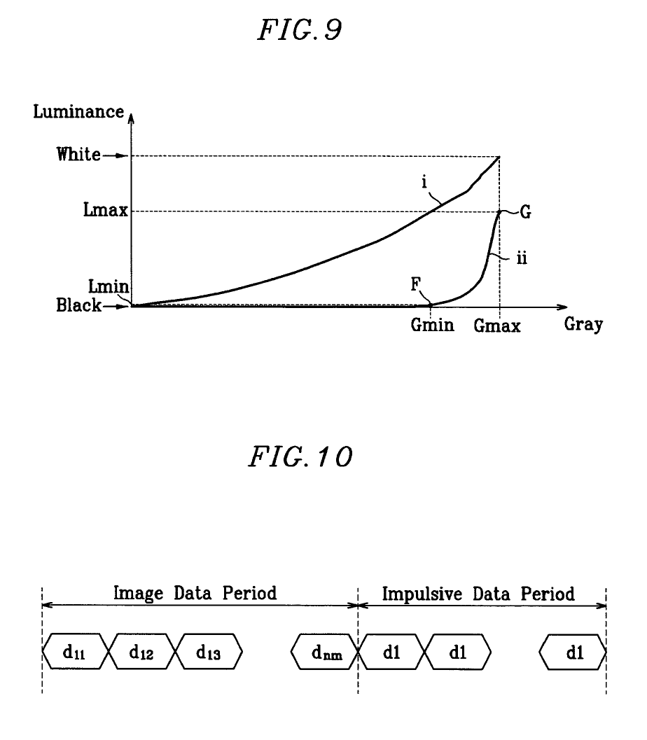

Referring back to FIG. 1, the gray voltage generator 800 generates a two-gray voltage collection related to the transmittance of the pixel (PX). The two-gray voltage collection is generated based on different gamma curves. This will be described below in more detail with reference to FIG. 9. The gate driver 400 is connected to the gate lines (G₁-Gₙ) of the liquid crystal panel assembly 300 and applies the gate signal, which consists of a combination of a gate-on voltage Von and a gate-off voltage Voff, to the gate lines (G₁-Gₙ). The data driver 500 is connected to the data lines (D₁-Dₘ) of the liquid crystal panel assembly 300. The data driver 500 selects a gray voltage from the gray voltage generator 800 and applies the selected gray voltage to the data lines (D₁-Dₘ) as the data signal. However, in the case where the gray voltage generator 800 does not supply voltages for the entire grays, but applies only a predetermined number of reference gray voltages, the data driver 500 divides the reference gray voltages to generate gray voltages for the entire grays and selects the data signal from the generated gray voltages.

The signal controller 600 controls the gate driver 400, the data driver 500, and so on. Each of the driving apparatuses 400, 500, 600, and 800 may be integrated and mounted on the liquid crystal panel assembly 300 in at least one IC chip form, mounted on a flexible printed circuit film (not shown) and then attached to the liquid crystal panel assembly 300 in a tape carrier package (TCP) form, or mounted on a printed circuit board (PCB) (not shown). Unlike the above, the driving apparatuses 400, 500, 600, and 800 may be integrated with the liquid crystal panel assembly 300 along with the signal lines (G₁-Gₙ, D₁-Dₘ), the thin film transistor switching element Q, and/or the like. Further, the driving apparatuses 400, 500, 600 and 800 may be integrated into a single chip. In this case, at least one of the driving apparatuses 400, 500, 600, and 800 or at least one circuit device forming them may be disposed outside the single chip.

The display operation of the liquid crystal display constructed above will be described in detail below with reference to FIGS. 9 and 10. FIG. 9 is a graph showing a gamma curve of the liquid crystal display according to an exemplary embodiment of the present invention, and FIG. 10 shows a waveform of a data signal in the liquid crystal display according to an exemplary embodiment of the present invention. The signal controller 600 receives input image signals R, G, and B, and an input control signal to control the display of the image signals R, G, and B from a graphics controller (not shown). The input image signals R, G, and B contain luminance information of each pixel (PX). The luminance has a predetermined number of grays, such as 1024 (=2¹⁰), 256 (=2⁸), or 64 (=2⁶). Examples of the input control signals may include a vertical synchronization signal Vsync, a horizontal synchronizing signal Hsync, a main clock signal MCLK, a data enable signal DE, and the like. The signal controller 600 processes the input image signals R, G, and B in such a way to be suitable for operating conditions of the liquid crystal panel assembly 300 and the data driver 500 based on the input image signals R, G, and B and the input control signal. The signal controller 600 generates a gate control signal CONT1, a data control signal CONT2 and so on, and sends the gate control signal CONT1 to the gate driver 400 and the data control signal CONT2 and a processed image signal DAT to the data driver 500.

The gate control signal CONT1 includes a scanning start signal (STV) to instruct of the start of scanning, and at least one clock signal to control an output cycle of the gate-on voltage Von. The gate control signal CONT1 may further include an output enable signal (OE) to define a sustaining time of the gate-on voltage Von. The data control signal CONT2 includes a horizontal synchronization start signal (STH) for informing of the start of transmission of image data for a row of pixels (PX), a load signal (LOAD) to instruct the data signal to be applied to the data lines (D₁-Dₘ), and a data clock signal (HCLK). The data control signal CONT2 may further include an inversion signal (RVS) to invert the voltage polarity of the data signal for the common voltage Vcom (hereinafter, “the voltage polarity of the data signal for the common voltage” is abbreviated to “the polarity of the data signal”).

Referring to FIG. 10, the image signal DAT sent from the signal controller 600 to the data driver 500 includes normal image data (d₁₁-dₙₘ) and impulsive data (g1). Gray values of the normal image data (d₁₁-dₙₘ) and the impulsive data (g1) are the same. However, the impulsive data (g1) may be formed by correcting the input image signals R, G, and B according to a predetermined rule. Referring to FIG. 9, the curve (i) is a luminance curve (gamma curve) indicating the normal image data (d₁₁-dₙₘ), and the curve (ii) is a luminance curve indicating the impulsive data (g1). The curve (i) may be determined according to a characteristic of the liquid crystal display. In the curve (ii), grays that are smaller than a predetermined gray (Gmin) indicated by “F” represent black, but grays that are greater than the predetermined gray (Gmin) represent a monotonically increasing luminance. At this time, the monotonically increasing luminance may be determined considering characteristics of the liquid crystal display. Unlike the above, the gamma curve indicated by the impulsive data (g1) may represent black with respect to the entire grays.

In the curve (ii) of FIG. 9, a point G indicates a point with the highest gray (Gmax) in the impulsive data (g1). At this time, the luminance is Lmax. Point F indicates a point where the luminance is the lowest value (Lmin) that is not 0, and the gray is Gmin. The luminance (Lmax) of the point G and the gray (Gmin) of the point F may be changed. In the case of the normally white mode, it is preferred that the luminance (Lmax) of the point G has a value corresponding to a voltage value that is higher than the voltage (Vc) at which the bending alignment of the OCB liquid crystals is broken. As an exemplary embodiment, the luminance of the point G may be black. At this time, the point F does not exist.

The data driver 500 receives the normal image data (d₁₁-dₙₘ) and the impulsive data (g1) and converts them into a normal analog data voltage and an impulsive analog data voltage, respectively, according to the data control signal CONT2 from the signal controller 600. The normal analog data voltage is selected from one of the two gray voltage collections from the gray voltage generator 800, which satisfies the curve (i) of FIG. 9. The impulsive analog data voltage is selected from one of the two gray voltage collections from the gray voltage generator 800, which satisfies the curve (ii) of FIG. 9. The data driver 500 applies the normal data voltage or impulsive data voltage to corresponding data lines (D₁-Dₘ).

The gate driver 400 applies the gate-on voltage Von to the gate lines (G₁-Gₙ) according to the gate control signal CONT1 from the signal controller 600, thereby turning on the switching element Q connected to the gate lines (G₁-Gₙ). The data signal applied to the data lines (D₁-Dₘ) is thus applied to a corresponding pixel (PX) through the turned-on switching element Q.

A difference between the voltage of the data signal applied to the pixel (PX) and the common voltage Vcom may be represented as a charge voltage of the liquid crystal capacitor (C_{LC}), i.e., a pixel voltage. The liquid crystal molecules may have different alignments depending on an amount of the pixel voltage. Accordingly, the polarization of light that passes through the liquid crystal layer 3 is changed. The change in the polarization is represented as a change in the transmittance of light by means of the polarizers 12 and 22 attached to the display panel assembly 300.

The above process is repeated on the basis of 1 horizontal period (also referred to as “1H”, which is the same as one cycle of the horizontal synchronizing signal Hsync and the data enable signal DE). Accordingly, the gate-on voltage Von is sequentially applied to all gate lines (G₁-Gₙ) and the data signal is applied to the pixel (PX), thereby displaying an image of one frame.

As shown in FIG. 10, the signal controller 600 alternately outputs the normal image data (d₁₁-dₙₘ) and the impulsive data (g1). In more detail, the signal controller 600 outputs the normal image data of one frame for all pixels and then outputs the impulsive data (g1). There are various methods of applying an impulsive data voltage corresponding to the impulsive data (g1) to the pixel (PX). Several examples thereof will be described below.

The first method includes applying the normal data voltage to all pixels once and then applying the impulsive data voltage to all pixels. The second method includes dividing all the pixels wherein the normal data voltage is applied to some pixels and the impulsive data voltage is applied to the remaining pixels. At this time, the impulsive data voltage may be applied to the remaining pixels at the same time. The third method includes applying the normal data voltage to some of the pixels and applying the impulsive data voltage to the pixels again. At this time, the impulsive data voltage may be applied at one time.

When one frame is finished, the next frame begins. The state of the inversion signal (RVS) applied to the data driver 500 is controlled so that the polarity of a data signal applied to each pixel (PX) becomes opposite to that in a previous frame (“frame inversion”). At this time, the polarity of a data signal that flows through one data line may be changed (for example, row inversion, dot inversion), or the polarities of data signals applied to one pixel row may be different (column inversion, dot inversion), depending on a characteristic of the inversion signal (RVS), even within one frame.

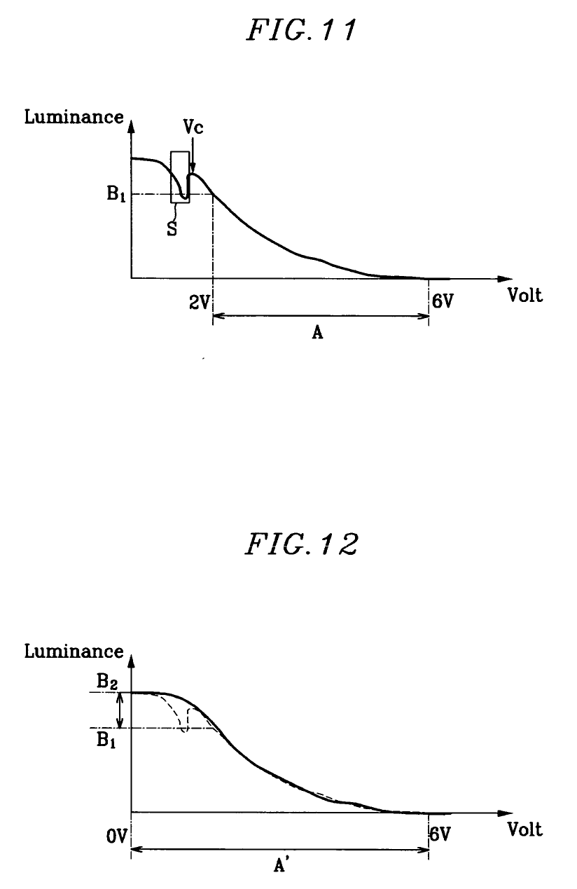

The luminance of the liquid crystal display will be described below in detail with reference to FIGS. 11 and 12. FIGS. 11 and 12 are graphs in which the luminance of the liquid crystal display of the normally white mode according to an exemplary embodiment of the present invention is represented as a function of a normal data voltage. FIG. 11 shows an example in which only the normal data voltage is applied, and FIG. 12 shows an example in which the impulsive data voltage is applied between times when the normal data voltages are applied (hereinafter, referred to as “impulsive driving”).

In the case where only the normal data voltage is applied as shown in FIG. 11, there exists an abnormal region (S) where luminance abruptly lowers as the voltage decreases. It is considered that the bending alignment of liquid crystals is likely to be broken at a voltage at a point where the luminance begins falling, i.e., at a threshold voltage (Vc) or less. Accordingly, in the case where only the normal data voltage is applied, the liquid crystal display can be driven only in a voltage range of over the abnormal region (S) in which the luminance shows a stably and monotonically decreasing characteristic, such as only in a voltage range of 2V or higher. Therefore, the highest luminance (B1) that can be displayed by the liquid crystal display is limited.

In the case of impulsive driving as in FIG. 12, the abnormal region in which luminance shows a monotonically decreasing characteristic and abruptly falls as the voltage decreases in the entire range does not exist. Accordingly, a voltage ranging from 0V to 2V can be used and the luminance that can be displayed is higher than that of FIG. 11.

The reason why the bending alignment is not broken as in an exemplary embodiment of the present invention may be considered to be as follows. In order for the bending alignment of the OCB liquid crystals to be broken, it is required that a voltage higher than the threshold voltage (Vc) is not applied for 500 ms or more. In the case of impulsive driving, however, a voltage higher than each frame threshold voltage (Vc) is applied and one frame time is about 16.7 ms, which is much shorter than 500 ms. Accordingly, the bending alignment is not broken. In the above-mentioned exemplary embodiment, the ratio (duty ratio) of pixels to which the normal data voltage and the impulsive data voltage are applied may be set to a variety of values. Preferably, the duty ratio may be set to 1:1.

In the above exemplary embodiment, the method of applying the impulsive data voltage has been described as an example. It is to be understood, however, that other methods are also possible. As described above, the OCB liquid crystal display is impulsively driven. Accordingly, luminance of the OCB liquid crystal display can be improved. Furthermore, since the bending alignment is not broken, the OCB liquid crystal display can stably drive regardless of the range of a driving voltage. Furthermore, an upper substrate and a lower substrate may be formed using alignment layers having different linear tilt angles, or may be formed to have a different baking temperature and time and a different thickness of an alignment layer even though the same alignment layer is used. Alternatively, the upper substrate and the lower substrate may be applied with different rubbing conditions, such as a texture of a rubbing material, a rubbing strength, a number of rubs, a rubbing table speed, and a number of rotations of a rubbing roll, when rubbing the upper alignment layer and the lower alignment layer, or they may be formed such that a rubbing direction of the upper substrate and the lower substrate forms an angle of 2° to 4°. Accordingly, when the liquid crystal display is driven, a bending alignment can be stably obtained without experiencing an asymmetric splay alignment step. Furthermore, the bending alignment can be obtained with a low driving voltage.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first substrate;
a first electrode formed on the first substrate;
a second substrate opposite to the first substrate;
a second electrode formed on the second substrate;
a liquid crystal layer interposed between the first substrate and the second substrate and aligned in an OCB method; and
first and second alignment layers that are formed on the first and second substrates, respectively, and that horizontally align the liquid crystal layer,
wherein a state of the first alignment layer and a state of the second alignment layer are different from each other, and
a normal data voltage, which is determined based on a first gamma curve representing luminance corresponding to external image information, and an impulsive data voltage, which is determined based on a second gamma curve representing luminance that is lower than that of the first gamma curve, are periodically and alternately applied to the first electrode.

2. The liquid crystal display of claim 1, wherein a linear tilt angle of liquid crystal molecules by the first alignment layer and a linear tilt angle of the liquid crystal molecules by the second alignment layer are different from each other.

3. The liquid crystal display of claim 1, wherein the first alignment layer and the second alignment layer include different materials.

4. The liquid crystal display of claim 1, wherein a thickness of the first alignment layer is different from that of the second alignment layer.

5. The liquid crystal display of claim 1, wherein the first alignment layer and the second alignment layer are formed using different baking temperatures and times.

6. The liquid crystal display of claim 1, wherein the first and second alignment layers are rubbed, and an angle formed by a rubbing direction of the first alignment layer and by a rubbing direction of the second alignment layer is 2° to 4°.

7. The liquid crystal display of claim 1, wherein the first alignment layer and the second alignment layer are rubbed, and any one of a texture of a rubbing material, a rubbing strength, and a number of rubs, is different.

8. The liquid crystal display of claim 1, wherein the second gamma curve represents black with respect to a gray that is lower than a predetermined value.

9. The liquid crystal display of claim 8, wherein the second gamma curve represents luminance that monotonically increases with respect to a gray that is higher than the predetermined value.

10. The liquid crystal display of claim 8, wherein the second gamma curve represents black with respect to all grays.

11. The liquid crystal display of claim 8, wherein the liquid crystal display is of a normally white mode.

12. The liquid crystal display of claim 11, wherein the impulsive data voltage is higher than a voltage at which a bending alignment of the liquid crystal layer is broken.

13. A liquid crystal display, comprising:
first and second electrodes disposed opposite to each other; and
a liquid crystal layer that is interposed between the first electrode and the second electrode and forms a bending alignment,
wherein a normal data voltage representing a luminance corresponding to external image information, and an impulsive data voltage that is higher than the lowest voltage that can sustain the bending alignment are periodically and alternately applied to the first electrode.

14. The liquid crystal display of claim 13, wherein the impulsive data voltage represents black.

15. The liquid crystal display of claim 13, wherein the impulsive data voltage is varied depending on input image information.

16. The liquid crystal display of claim 15, wherein the impulsive data voltage corresponding to a predetermined gray or less represents black.

17. The liquid crystal display of claim 13, wherein the liquid crystal display is of a normally white mode.

18. The liquid crystal display of claim 13, wherein the ratio of pixels to which the normal data voltage and the impulsive data voltage are applied is 1:1.
